(19) United States
(12) Patent Application Publication
(10) Pub. No.: US 2009/0281777 A1
(43) Pub. Date: Nov. 12, 2009

(54) Workflow Modeling With Flexible Blocks

(76) Inventors: Stefan Baeuerle, Rauenberg-Rotenberg (DE); Marita Kruempelmann, Dielheim (DE); Marek Kowalkiewicz, St. Lucia (AU); Ruopeng Lu, Taringa (AU); Sonia Lippe, Heidelberg-Kirchheim (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 11/963,776

(22) Filed: Dec. 21, 2007

(51) Int. Cl. G06G 7/48

(52) U.S. Cl. 703/6

(57) ABSTRACT

Disclosed is a method that includes providing tasks associated with a process, one or more of the tasks having a corresponding undetermined inter-dependency between the one or more of the tasks and other of the tasks, associating with the process one or more constraints specifying requirements regarding use of at least one of the tasks, the one or more constraints having corresponding graphical representations, and generating an instance of the process based on the one or more constraints to determine the corresponding undetermined inter-dependency between at least one of the one or more of the tasks and the other tasks.

### BACKGROUND

The present disclosure relates to workflow modeling, and more particularly to workflow modeling with flexible blocks.

Commercial business process management systems (BPMS) may employ graph-based workflow models as the mechanism to represent and enforce control over process automation and execution. A typical graphical workflow model is generally prescriptive in that it captures all, or most, execution possibilities of the steps and options within the process. At runtime, multiple instances of the same workflow are created according to the same workflow model.

In contemporary dynamic business environments, processes continually change in response to advances in technology, new methods and practices, and changes in laws and policies (e.g., requirements such as the implementation of industrial best practices and government regulations such as the Sarbanes-Oxley Act). Furthermore, these processes often have to account for exceptional cases, and thus have to deviate from prescribed procedures. These exceptional cases may or may not be foreseen.

### SUMMARY

Described herein are methods, apparatus and computer program products to implement workflow modeling and adaptations using flexible blocks. Such flexible blocks enable defining the workflow model in a more relaxed or “flexible” manner that enables individual instances to determine their own (unique) processes instead of representing and implementing workflow control through a rigid and highly prescriptive model that attempts to capture every step and every option within the process. A model's flexibility may be defined as the ability of the process to execute based on a partially defined model. A full specification of the model is done just before or during runtime and may be unique to each instance.

By using flexible blocks, a flexible workflow model is defined for a particular business process at design time. At runtime, or prior to execution, the workflow model for each workflow instance can be individualized (concretized) by adapting the general workflow model according to specific needs. Such adaptations generally include selecting tasks, changing the order of execution, etc., and may be performed by users (e.g., domain experts) and/or automatically by, for example, applying handling rules. A flexible block identifies a flexible region of a workflow model that can be changed at runtime or just before. A flexible block includes a set of un-structured or semi-structured workflow tasks from which one or more tasks may be selected (e.g., through an automatic procedure or by a user such a domain expert) and the tasks inter-dependencies determined to form a fully-specified model, thus resulting in a concrete execution model (e.g., model instance) which is designed at runtime in a just-in-time manner.

Some implementations of the methods, apparatus and computer program products described herein use graphical notations to represent the constraints associated with the process that specify requirements regarding use (e.g., selection) of at least one of the tasks to instantiate the process. During the runtime adaptation of the process having one or more flexible blocks, generating an instance of the process is based on these constraints. A set of graphical notations includes, for example, graphical notations for task selection constraints. Task-select constraints specify restrictions regarding which and how many tasks are required to be chosen for a process instance.

As further described herein, several adaptation strategies may be used to instantiate the processes with flexible blocks, including human-controlled adaptation in which users provide input used in the adaptation procedure and/or default-rules-based adaptation strategies. In some embodiments adaptations may be performed during runtime, while in some embodiments adaptation may be performed prior to execution of a generated instance of the process.

In one aspect, a method is disclosed. The method includes providing tasks associated with a process, one or more of the tasks having a corresponding undetermined inter-dependency between the one or more of the tasks and other of the tasks, associating with the process one or more constraints specifying requirements regarding use of at least one of the tasks, the one or more constraints having corresponding graphical representations, and generating an instance of the process based on the one or more constraints to determine the corresponding undetermined inter-dependency between at least one of the one or more of the tasks and the other tasks.

Embodiments of the method include one or more of the following features.

The associated constraints specifying requirements regarding use of the at least one of the tasks may include associated constraints specifying requirements regarding selecting the at least one of the tasks to be included in the generated instance of the process.

Generating the instance of the process may include generating a fully-specified instance.

The method may further include receiving a user-input relating to inter-dependencies between the tasks of the process. Generating the instance of the process based on the one or more constraints may include generating the instance of the process based on the one or more constraints and the received user-input.

Receiving user-input may include receiving user input during at least one of the generating of the instance of the process and/or execution of the generated instance of the process.

Generating the instance of the process based on the one or more constraints may include determining whether the generated instance satisfies the requirements specified by the one or more constraints.

The one or more constraints may include a cardinality constraint specifying a number of tasks that are to be selected from the tasks. The cardinality constraint may be a variable having an assigned value determined by a user.

The one or more constraints may include a mandatory execution constraint specifying an identity of one or more tasks from the tasks that have to be performed in the instance of the process.

Generating the instance of the process may include generating the instance of the process based on default rules. The default rules may include rules that specify an event, cause an evaluation of at least one condition if the event has occurred, and cause execution of a specified operation based on the evaluation of the at least one condition. The event may specify completion of an adaptation of the process and the specified operation may cause performance of the process. The event may specify that an adaptation of the process has not been completed and the specified operation may cause an adaptation of the process to be performed. The specified operation may include selection of one of the tasks.

In another aspect, a computer program product residing on a computer readable medium and comprising computer instructions is disclosed. The computer instructions, when executed on a processor-based device, cause the processor-based device to provide tasks associated with a process, one or more of the tasks having a corresponding undetermined inter-dependency between the one or more of the tasks and other of the tasks, associate with the process one or more constraints specifying requirements regarding use of at least one of the tasks, the one or more constraints having corresponding graphical representations, and generate an instance of the process based on the one or more constraints to determine the corresponding undetermined inter-dependency between at least one of the one or more of the tasks and the other tasks.

Embodiments of the computer program product may include one or more of the features described herein with respect to the method.

In yet another aspect, a system is disclosed. The system includes a processor, and a storage device coupled to the processor, the storage device storing computer instructions. The computer instructions, when executed on the processor, cause the processor to provide tasks associated with a process, one or more of the tasks having a corresponding undetermined inter-dependency between the one or more of the tasks and other of the tasks, associate with the process one or more constraints specifying requirements regarding use of at least one of the tasks, the one or more constraints having corresponding graphical representations, and generate an instance of the process based on the one or more constraints to determine the corresponding undetermined inter-dependency between at least one of the one or more of the tasks and the other tasks.

Embodiments of the system may include one or more of the features described herein with respect to the method.

The subject matter may be implemented as, for example, computer program products (e.g., as source code or compiled code tangibly embodied in computer-readable media), computer-implemented methods, and systems.

The subject matter described herein can be implemented to realize one or more of the following advantages. Use of flexible blocks enables the deployment of flexible workflow models and avoids rigidity of models to thus enable modifications to the models to be made. Furthermore, by designing models with flexible blocks it is not necessary to capture every execution possibility of the model. The flexible blocks described herein provide meaningful graphical representations of constraints to facilitate control over modeling and adaptation procedures. Use of workflow models with flexible blocks enables use of a wide range of runtime and pre-deployment adaptation methodologies to generate process instances.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a schematic diagram of stages performed in the implementation of a workflow-based process.

FIG. 2 is a diagram of exemplary flexible blocks.

FIG. 3 is a diagram of an exemplary flexible block with a cardinality constraint.

FIG. 4 is a diagram of an exemplary flexible block associated with a variable cardinality constraint.

FIG. 5 is a diagram of an exemplary flexible block associated with a cardinality constraint and a mandatory execution constraint.

FIG. 6 is a diagram of an exemplary flexible block associated with a variable cardinality constraint and with a mandatory execution constraint.

FIG. 7 is a diagram of an exemplary workflow model with a flexible block.

FIG. 8 is a diagram of an exemplary instance of the workflow model of FIG. 7, resulting from a pre-execution human controlled end-to-end adaptation.

FIG. 9 is an exemplary state transition diagram of possible transitions for flexible block adaptation and execution operations.

FIG. 10 is a diagram of another exemplary workflow model with a flexible block.

FIG. 11 is a diagram of another exemplary workflow model with a flexible block associated with a variable cardinality constraint.

FIG. 12 is a diagram of another exemplary workflow model with a flexible block associated with a variable cardinality constraint and a mandatory execution constraint.

FIG. 13A is a diagram of yet another exemplary workflow model with a flexible block.

FIG. 13B is a diagram of an instance of the process resulting from application of default handling rules on the workflow model of FIG. 17A.

FIG. 14 is a flowchart of an exemplary modeling and adaptation procedure.

FIG. 15 is a schematic diagram of an exemplary computing system for performing workflow modeling and adaptation procedures.

Like reference numbers and designations in the various drawings indicate like elements.

### DETAILED DESCRIPTION

Described herein is a method, apparatus and computer program product to generate an instance of a workflow model, representing a process, that includes flexible components such as flexible blocks. The flexible block includes one or more tasks with respect to which the inter-dependency between that one or more of the tasks and other tasks of the process are undetermined. The process is associated with one or more constraints that specify requirements regarding the use of at least one of the tasks of an instance of the process (i.e., a particular selection from tasks of the process results in one instance, while another selection from the tasks results in another instance). The requirements regarding use include requirements regarding selection of tasks.

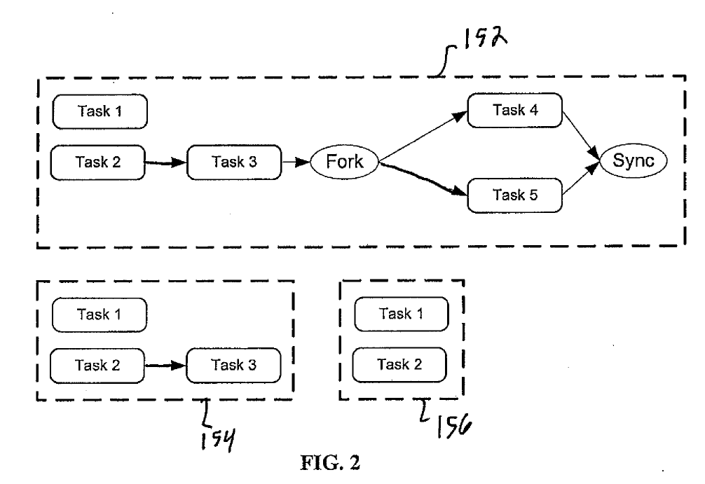

Generally, a workflow graph is represented as a directed-acyclic graph (DAG) that includes of a set of nodes and a set of directed edges. A node represents either a task in the workflow or a coordinator. A task can be either an automated and/or manual atomic activity, or it can be a sub-process that includes several atomic activities (e.g., a sequence of tasks that includes, for example, Task 2, Task 3, Fork, Task 4, Task 5 and Sync, as shown in FIG. 2). A coordinator is a node that directs the execution flow of the process and includes: Begin, End, Fork(AND-Split), Sync(AND-Join), Choice(OR-Split), and Merge(OR-Join).

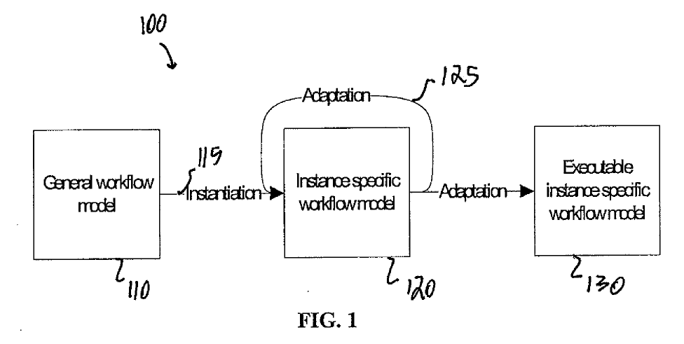

Referring to FIG. 1, showing stages 100 performed in the implementation of a workflow-based process, there are generally three types of workflow models: a) a general workflow model 110, b) an instance specific workflow model 120 (also called instance), and c) an executable instance specific workflow model 130 (also referred to as executable instance). A general workflow model is typically prepared by a domain expert (modeler). The model serves as a template for instances that are subsequently adapted and executed. As will be described below in greater detail, the general workflow model defines the flexibility of executed models by providing constraints associated, for example, with flexible blocks, detailing what parts of model can be modified and how that modifying can be done (e.g., by introducing new tasks, determining execution order, etc.). Because some flexibility in the generation of instances of the process' workflow model is left to be determined at a time subsequent to the initial design and development of the workflow model, the general workflow model may be considered as a partially specified model. For each workflow (model) instance, an instance-specific workflow model is created according to the general workflow model. This is referred to as instantiation. Process-adaptation operation is performed on the instance-specific workflow model, if it contains a flexible block.

The adaptation procedure includes making decisions on flexible components of the partially specified workflow model. In some embodiments, the adaptation may be incomplete in that the resultant generated instance is still not fully specified and may still include one or more flexible components. The resultant partially specified instance may thus also be subjected to further adaptation processing as indicated by the iterative adaptation loop 125 in FIG. 1.

In a fully-specified generated instance of a workflow model, the flow and inter-dependencies between various nodes (e.g., tasks and flow nodes) of the resultant model are defined and can thus be executed on a management system platform. However, in some embodiments, the resultant model does not have to be fully specified to be considered executable instance specific workflow model. As there may be choice nodes (alternative execution paths) in the model, only those paths that are actually executed need to be fully specified. Furthermore, and as will become apparent below, a partially specified model that is adapted during runtime based on, for example, input from a user, may also be executed without all the inter-dependencies between the various nodes (including nodes that are traversed during execution) being fully defined.

As noted, the workflow models described herein include at least one flexible component such as a flexible block. Referring to FIG. 2, diagrams of three examples of flexible blocks 152, 154 and 156 are shown. In implementations described herein, a flexible block is represented as a dashed-line block that includes one or more tasks. A flexible block may be part of a larger process or it may constitute the entire process. The example flexible blocks illustrated in FIG. 2 each include a set of tasks (also referred to as workflow steps, or sub-workflows), with respect to which the inter-dependency between at least one of the tasks and the other tasks of the flexible blocks (i.e., their relationship to each other in terms of, for example, whether the tasks are selected for execution and/or the order of execution) is not defined, i.e., the tasks to be selected and their order of execution are undetermined. In the examples shown in FIG. 2 the various flexible blocks each include two steps (tasks or sub-processes). For example, the top flexible block 152 includes Task 1 as one of tasks (workflow steps) of the flexible block, and the sequence of operation that includes Task 2, Task 3, a Fork node, Task 4, Task 5 and a Sync node constitute the second task of the flexible block. As shown, in the flexible block 152 of FIG. 2 the inter-dependency between Task 1 and the sequence of operations constituting the second task is undetermined. Thus, instantiation of the process that includes this flexible block may result in one instance in which Task 1 is connected to Task 2, and thus Task 1 has to be executed before execution of the sequence of operations beginning with Task 2, or it may result in another instance in which Task 1 is connected to the Sync node, in which case execution of the sequence of operations beginning with Task 2 precedes the execution of Task 1. Alternatively, in other instances of a process that includes the top flexible block 152 Task 1 may be arranged so that it is scheduled to execute in parallel with the sequence of operations beginning with Task 2.

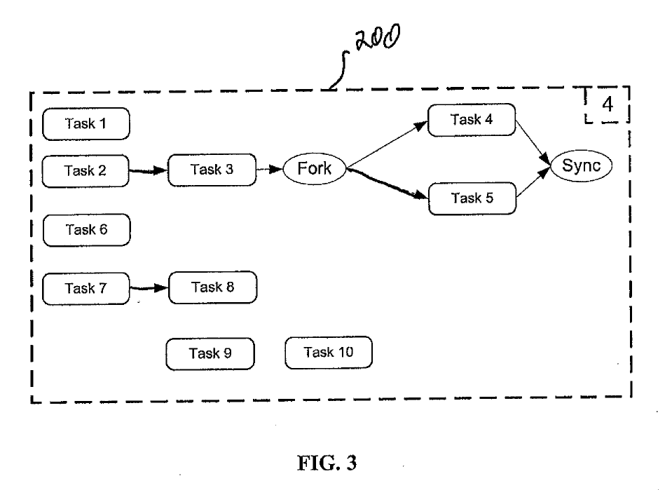

To enable generating an instance of a process having a flexible block, one or more constraints that specify requirements regarding use (e.g., selection and/or ordering of tasks) of at least one of the tasks (workflow steps) in the flexible block are associated with the process. Referring to FIG. 3, a flexible block 200 with a cardinality constraint is shown. A cardinality constraint is a constraint that specifies a number of tasks that are to be selected from the tasks corresponding to the flexible block. The cardinality constrain generally indicates that n out of m tasks included in the flexible block need to be selected.

As shown in FIG. 3, the flexible block includes six tasks, or sub-processes, (namely, Task 1, the sequence of operations beginning with Task 2, Task 6, the sequence of operations beginning with Task 7, Task 9 and Task 10) whose inter-dependencies to the other tasks is undetermined. The cardinality constraint is represented as a value placed, for example, at the top right corner of the flexible block, and in some embodiments may be enclosed inside a dashed square. Other graphical notations to represent the cardinality constraint may be used. The number in top right corner indicates a number of tasks that have to be selected to proceed with the workflow. Thus, any combination of tasks, provided that at least four of them are chosen for concretizing the process, is possible. For example, one instance of the process may be one in which Task 1, Task 6, the sequence of operations beginning with Task 7 and Task 10 are selected. In that process instance, the sequence of operation beginning with Task 2 and Task 9 may not be selected.

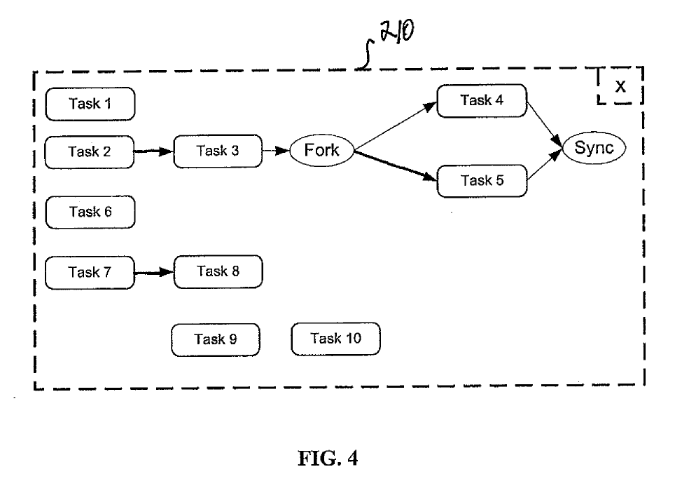

Referring to FIG. 4, showing another exemplary embodiment of a flexible block 210 associated with a cardinality constraint, the number of tasks that have to be executed may be a variable number, represented as “x”. The value for the variable “x” may be, in some embodiments, assigned during design time (e.g., when an instance of the workflow model is being generated), or it may be left as a variable whose value is assigned by a user, e.g., during runtime of the process. In some embodiments, an additional attribute of the variable x may be its range, for example xε<2, 5>. That is, under such circumstances, the cardinality constraint requires that the number of tasks selected for execution be at least 2, but not more than 5.

A special type of a cardinality constraint that may be associated with a process having a flexible block is the cardinality constraint with mandatory execution. This type of constraint specifies the number of tasks that need to be selected for the instantiation of the process to proceed, and additionally specifies mandatory tasks that have to be selected (a flexible block associated with this type of constraint is referred to as “n out of m flexible block with mandatory execution”).

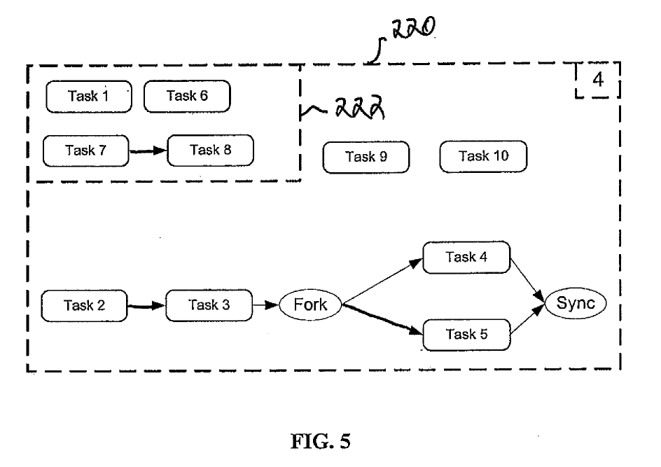

Referring to FIG. 5, a flexible block 220 associated with a cardinality constraint and with a mandatory execution constraint is shown. The flexible block 220 includes six tasks or sub-processes (namely, Task 1, the sequence of operations beginning with Task 2, Task 6, the sequence of operations beginning with Task 7, Task 9 and Task 19). A number in top right corner indicates a number of tasks that have to be completed in order to proceed in the workflow. A box in top left corner (which may have a dashed frame) surrounds all tasks that are mandatory. Thus, in any instantiation of the process that includes the flexible block 220 of FIG. 5, Task 1, Task 6, and the sequence of operations beginning with Task 7 have to always be selected. In this example, any combination of tasks, provided that all of the ones surrounded by the top left box, and also provided that at least four out of all tasks in the flexible block are executed, is possible. Thus, under these circumstances, an instantiation of the process in which exactly four tasks are selected for execution, requires that one of three non-mandatory tasks (namely, the sequence of operation beginning with Task 2, Task 9 and Task 10) have to be selected. While in the implementation shown in FIG. 5 the representation of the cardinality constraint and the mandatory execution constraint is achieved using boxes at the two top corners of the flexible block, other ways to graphically represent these constraints may be used.

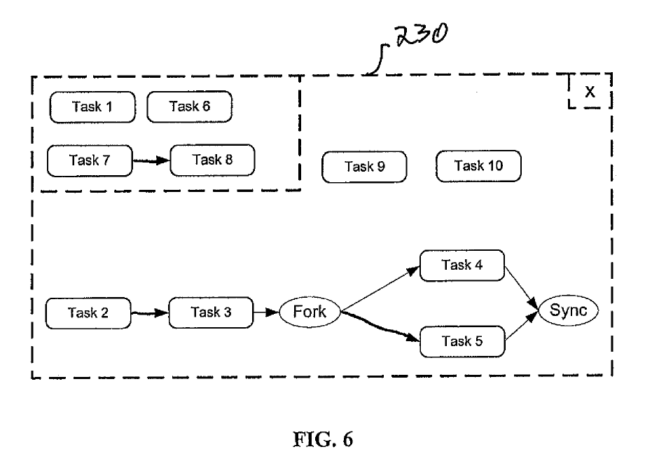

As with the cardinality constraint described in relation to FIGS. 3 and 4, the minimum number of tasks to be executed may be provided by a user during the adaptation (instantiation) phase. Referring to FIG. 6, an example of a flexible block 230 with cardinality and mandatory execution constraints is shown. The variable “x” represents the number of tasks that are to be selected by a user during the adaptation procedure to generate an instance of the process. An additional attribute of the variable x may be its range, for example xε<2, 5> requiring, in the example shown, that the number of tasks selected for execution be at least 2, but no more than 5. Other types of constraints to associate with a process (the general workflow model) may be used.

Once a general workflow model having a flexible block with associated constraints is defined, the workflow model is transformed into an instance specific workflow model in a process referred to as adaptation. Process adaptation may, in some embodiments, result in a partially specified workflow model. Process adaptation can be performed automatically, based on certain adaptation rules, or by a human, based on additional criteria, not included in the general workflow model. Either automatic or human-driven, adaptation is performed based on the constraints associated with the process as defined by the general workflow model. In performing the adaptation process, the constraints associated with the process cannot be breached. The inter-dependencies between at least one of the tasks whose interdependencies with other tasks were previously undetermined and the other tasks of the process are determined during the adaptation process, and an instance of the process is thus generated. During the adaptation process decisions regarding who should be the concretizing agent (human or computer system) are made.

There are several types of adaptation strategies that may be used to generate instances of the general workflow model which include: pre-execution human controlled end-to-end adaptation, pre-execution human controlled adaptation, runtime human-controlled adaptation, runtime default behaviour adaptation. These adaptation strategies may be grouped into two strategy classes: pre-execution adaptation strategies, and runtime adaptation strategies. Pre-execution adaptation is performed before executing a workflow instance. In pre-execution adaptation a single workflow instance is started after the adaptation process is completed. Pre-execution adaptation strategies could also be used to create new “templates” (general workflow model), less flexible than the original one, which could then be used to subsequently create further instances. In other words, the pre-execution adaptation of a workflow model could be used to generate a resultant workflow model that while is not fully specified it is nevertheless more specific than the original workflow model. Such an approach of creating a new template enables, for example, tailoring company wide general workflow models to the needs of particular departments.

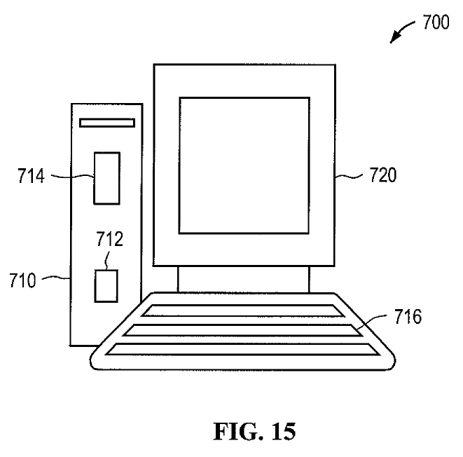

Runtime adaptation relates to one instance of general workflow model. The runtime adaptation is performed just-in-time. Thus, under this approach, it is possible to start executing a not-fully-adapted workflow, and once a workflow engine (i.e., the engine, implemented, for example, on a computer system such as the system 70 shown in FIG. 15, performing the adaptation process) comes upon a non-adapted component (e.g., a flexible block), adaptation procedure are performed at that point on the component. These adaptation procedures may involve, for example, prompting the user to provide input regarding, for example, selection of one or more tasks, etc., and/or applying default behavior.

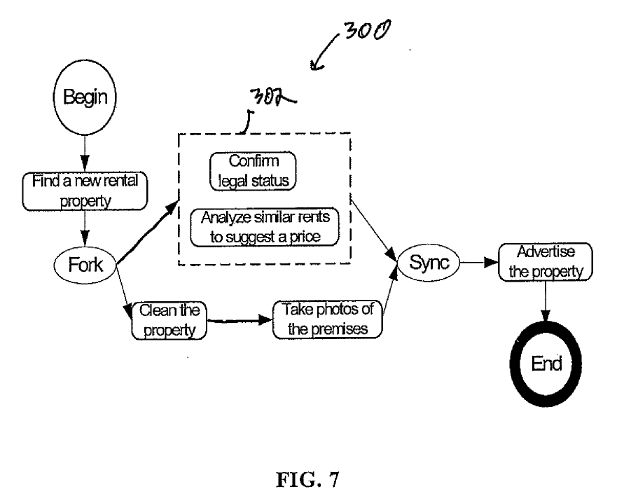

To facilitate understanding of the above-identified adaptation strategies, reference is made to an exemplary simplified workflow model 300 illustrated in FIG. 7. As shown in FIG. 7, the workflow model 300 depicts a workflow related to finding, preparing, and advertising a rental property by a real estate agency. The model is specified as follows. At first, a new rental property has to be found (FIND A NEW RENTAL PROPERTY). After finding the property, there are two parallel sequences of action executed. The first one focuses on legal and financial issues. The two tasks (CONFIRM LEGAL STATUS and ANALYZE SIMILAR RENTS TO SUGGEST A PRICE), included in a flexible block 302 of the workflow model, can be run in any order (including parallel execution). Additional tasks may be included in the flexible block of this process, and further constraints may be associated with respect to the flexible block. It is to be noted that while the illustrated flexible block does not explicitly identify constraints, it implicitly indicates that all tasks must be selected. In other words, where the flexible block is not associated with an explicit graphically represented constraint, the flexible block is deemed to be associated with the implicit constraint requiring selection of all tasks. The second group (or sequence) of activities is related to visual preparation of the property and photographing it before advertising.

The workflow model depicted in FIG. 7 cannot be executed until decisions (e.g., task selection) pertaining to the model's flexible block are made. As described herein, those decisions may be made before process execution, during process execution, or both.

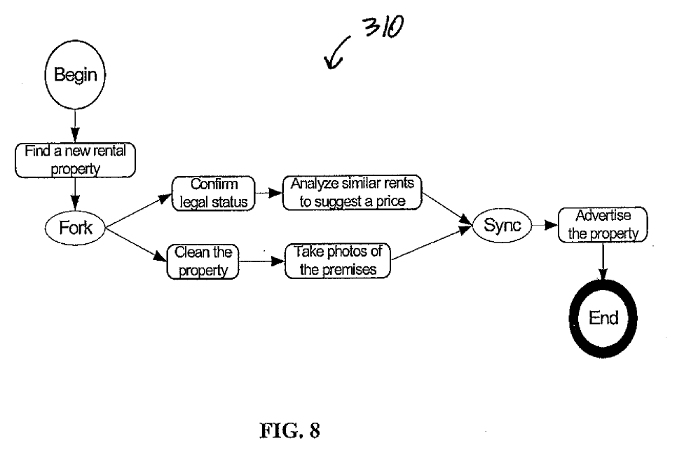

Referring to FIG. 8, a specific instance 310 of the workflow model of FIG. 7, resulting from a pre-execution human controlled end-to-end adaptation is shown. Under these circumstances, the adaptation for the general workflow model is performed by a user and takes place before the process is executed. At the conclusion of the adaptation process, the resultant model instance is fully specified. In FIG. 8, the user providing the input can be, for example, authorized personnel of a rental agency such as the agency's manager. In some cases, the manager may specify the process completely. The process instance depicted in FIG. 8 is thus fully specified and does not include any flexible component (e.g., flexible blocks) requiring adaptation decisions. As shown in the generated instance of FIG. 8, based on user input received during the adaptation process but before execution of the generated instance, both tasks in the flexible block 302 of the workflow model 300 in FIG. 7 were selected and the ordering decisions made with respect to them were such the task of ANALYZE SIMILAR RENTS TO SUGGEST A PRICE had been determined to be performed after the task of CONFIRM LEGAL STATUS.

In some embodiments, adaptation operations to generate instances of the workflow model are performed automatically by applying default behaviour rules. Adaptation procedures implemented through such default behaviour rules are referred to as runtime default behavior adaptation strategies. Generally, default behavior adaptations are not performed pre-execution because it is expected that a human user will adapt the process and thus provide input through a user interface during runtime to control the adaptation operations. When user input is not received, the default handling rules will generally be reverted to. Runtime default behavior adaptations are thus generally enforced in situations where there are no responses from the user. The default behavior rules include, for example, default task selection rules corresponding to a model's flexible block which are performed subject to the constraints associated with the flexible block. Default behaviour can be graphically defined for each flexible block. The default rules may then be translated from the default behavior model and applied for execution.

An example of a default rule that may be applied to a flexible block in the event that user-input in relation to task selection and/or ordering is not received could be a rule specifying ALL STEPS SHOULD BE RUN IN PARALLEL. Application of such a rule would result in all the tasks provided in the flexible block being selected and are run in parallel (subject to any of the constraints associated with the flexible block).

In some embodiments, a rule-based default behavior adaptation procedure is implemented using a rule inference engine. A typical rule inference engine is a software component configured to control the automation of business process. (which may be implemented in software on a computer system such as the system 700 shown in FIG. 15). The engine accepts as input a set of pre-defined rules and relevant runtime data, based on which it makes decisions on how and when to perform the corresponding actions to achieve certain goal. At runtime, the rule-inference engine examines data and control conditions and determines, for example, the task selection corresponding to relevant business activities. A typical rule in a workflow management system (or WFMS) can be represented using the Event-Condition-Action (E-C-A) paradigm:

```
    On event₁,...,eventₘ
IF condition₁,...,conditionₙ
    DO action₁,...,actionₖ
```

An event specifies the triggering event that causes, when that event occurs, an evaluation of the conditions specified in the rule. In other words, the event portion of the rule specifies when a rule is to be evaluated. The event portion of the rule thus corresponds to a transformation from one execution state to another execution state. Events do not include or require an activity to be performed (either by a system implementing the workflow management system, or by a user providing input in the course of the adaptation operation).

A Condition indicates the specified pre-conditions to be checked before any action is triggered. An Action specifies what subsequent activities are to be performed are, if the condition(s) is satisfied. Performance of an action can, in turn, result in the occurrence of another event that may itself trigger an action corresponding to some other rule.

Adaptation handling rules conforming to the paradigm described herein may thus be used to implement adaptations processes for workflow models with flexible blocks. Such adaptation handling rules perform two principal functions. First, the adaptation handling rules can be used to specify the adaptation constraints for flexible block. In other words, the handling rules are used to determine if the constraints associated with a flexible block have been satisfied. Second, adaptation handling rules can be used to handle pre-deployment and perform either human-controlled or default-based runtime adaptations. For each flexible component in the general workflow model, the default behaviour may also be defined.

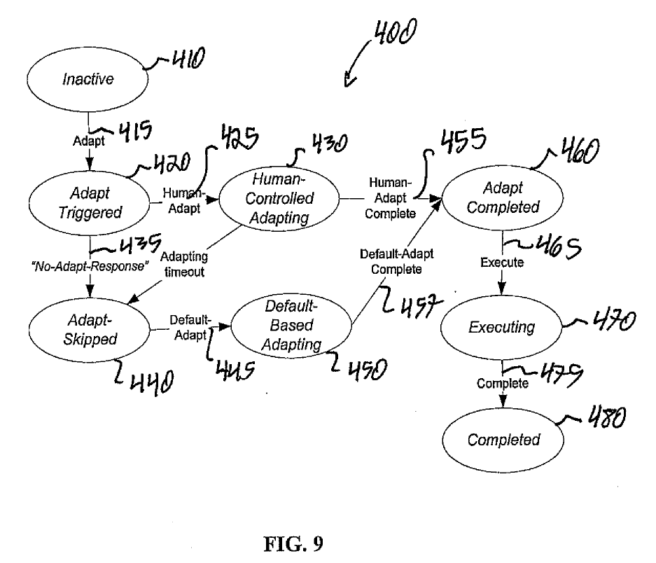

Referring to FIG. 9, a state transition diagram 400 depicting possible transitions for flexible block adaptation and execution operations is shown. The state transition may be used in conjunction with adaptation operations performed for an entire workflow model, or individually for flexible blocks comprising the workflow model. The labels indicated on the edges are the actions (or events) that cause a change in the state of the processing of the model or the flexible block. As shown the various execution states for flexible blocks include the following states: INACTIVE, ADAPT-TRIGGERED, ADAPT-SKIPPED, DEFAULT-BASED ADAPTING, HUMAN-CONTROLLED ADAPTING, ADAPT COMPLETED, EXECUTING, and COMPLETED. The state of a model or flexible block is changed implicitly by the actions performed thereon.

The INACTIVE state 410 indicates that adaptation has not yet begun and thus has not yet been activated. The action (or event) that triggers adaptation for a flexible block (or workflow model) is the ADAPT action 415 and the consequent state to which the flexible block transitions is ADAPT-TRIGGERED 420. HUMAN-CONTROLLED ADAPTING 430 is the state set by the action HUMAN-ADAPT 425, indicating that the flexible block is being adapted by input from a user. Thus, in some embodiments, upon the commencement of the adaptation procedure (triggered by the ADAPT action 415), an adaptation engine (e.g., a module implemented, for example, on the computing system 700 shown in FIG. 15 and configured to perform adaptation operations on a workflow model and/or the model's flexible blocks) will first determine if a user is to provide input based upon which, at least in part, decisions regarding selection of tasks will be performed.

The ADAPT-SKIPPED state is the state 440 set by an event corresponding to a determination that no human-controlled adaptation (e.g., via a user interface) is performed. Thus, the triggering event of the ADAPT-SKIPPED state is the NO-ADAPT-RESPONSE event 435 that indicates that no user-input is to be provided. The ADAPT-SKIPPED state in the adaptation procedure for the process and/or any of its flexible blocks may also be achieved in the event that the HUMAN-CONTROLLED ADAPTING state has been reached, but user input, even though was expected, had not been provided, and consequently a corresponding wait period for receiving input from the user has timed out. Under these circumstances, the ADAPT-SKIPPED state 440 is triggered through the occurrence of an ADAPTING TIMEOUT event 437, which results in the transition from the HUMAN CONTROLLED ADAPTING state 430 to the ADAPT-SKIPPED state 440. It is to be noted that the NO-ADAPT-RESPONSE event 435 can be defined as an event that occurs when a waiting period (which may be different than the waiting period for the ADAPTING TIMEOUT event 337) expires, or a user (e.g., domain expert) decides to forego human-controlled adaptation (e.g., the system receive user-input indicating that human-controlled adaptation is not to be performed). The waiting period of both ADAPTING TIMEOUT and NO-ADAPT-RESPONSE can be set to values according to system defaults (e.g., internal system settings).

The action/event resulting from the decision to skip human-controlled adaptation and perform default-based adaptation is denoted as the DEFAULT-ADAPT event 445 which sets the DEFAULT-BASED ADAPTING state 450. When the workflow management system transitions to this state, adaptation of the workflow model is performed based on default rules as described herein. Thus, to generate an instance of the workflow model (i.e., of the process represented by the workflow model), default rules are applied to, for example, the flexible blocks to select the tasks included in the flexible blocks.

As further shown in FIG. 9, upon completion of either human-controlled adaptation (performed when adaptation procedure 400 is in the HUMAN CONTROLLED ADAPTING STATE 430) or default-based adaptation (performed when the procedure 400 is in the DEFAULT-BASED ADAPTING state 450) the respective HUMAN-ADAPT COMPLETE event 455 or DEFAULT-ADAPT COMPLETE event 457, and sets ADAPT COMPLETED state 460 indicating that adaptation for the flexible block has been completed. In some embodiments, before the ADAPT COMPLETED state is completed, the adaptation is validated to determine if the flexible block constraints (e.g., N OUT OF M SELECTION) have been satisfied. In the event that the constraints associated with various flexible blocks have not been satisfied, the adaptation procedure 400 may revert to one of its adaptation states (e.g., the DEFAULT-BASED ADAPTING state 450) to perform additional adaptation operation that would remedy the constraint breach.

Execution of the generated instance is set by the EXECUTE action/event 465, which indicates that the execution of the process with respect to which adaptation had been performed has commenced. The EXECUTE event 465 causes a transition to the EXECUTING state 470, during which time the tasks selected from the process' flexible blocks are executed. The action/event triggering completion of process is the COMPLETE event 475, which sets the final state of the transition diagram of the workflow model to COMPLETED state 480.

In circumstances where adaptation of a workflow model/process are performed using default-based adaptation operations (e.g., in the event that a user decides to forego human-controlled adaptation or no response has been received from the user after the HUMAN-CONTROLLED ADAPTING state 430 shown in FIG. 9 has been reached) default-based rules for adapting the flexible block(s) of the model are used to generate the process instance. As noted, default rules are also used to perform a determination of whether the constraints for adapted flexible blocks have been satisfied.

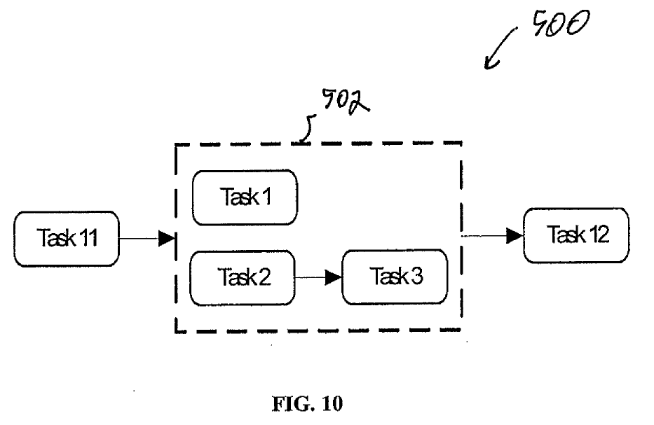

To describe the default rules that are used in the adaptation processes of flexible blocks, reference is made to FIG. 10, showing an exemplary workflow model 500 with a flexible block 502. An embodiment of adaptation handling rule, denoted rule r1, to determine if the constraints of the flexible block 502 are satisfied is shown below in Table 1.

TABLE 1
Adaptation Handling Rule for a Flexible Block

| | |
|---|---|
| r1 | ON FB adapt-complete |
| | IF FB contains {T1, T2, T3} |
| | DO execute FB |

In the above rule r1, the FB is the identifier of the flexible block. The adaptation rule r1 determines if the event specified event of the rule has taken place. Here, the triggering event is occurrence of an adapt-complete event (similar to the event 435 or 437 shown in FIG. 9) that indicates that adaptation operations performed for the flexible block FB 502 have completed. The occurrence of the adapt-complete event indicates that the flexible block has been adapted, requiring that a determination of whether the adapted block satisfies the constraints associated with the flexible block be performed. Accordingly, upon the occurrence of the specified event, the conditions specified in rule r1 are evaluated. In this case, the flexible block 502 has an implicit constraint requiring selection of all the tasks. Accordingly, the conditions evaluated, as specified by rule r1, are whether the adapted flexible block contains the tasks that were assigned to it (namely, the T1, T2 and T3 tasks). If upon evaluation of the condition it is determined that the constraints associated with the flexible block has been satisfied, the action specified in rule r1, namely, execution of the flexible block, is performed. In some embodiments, the rules, including the constraint-checking rules, may include an ELSE statement to specify the remedial action to be taken when the adaptation constraint specified in the rule is not satisfied.

As will be described in greater detail below, default rules may be used in performing the actual adaptation operations of the flexible block and/or the workflow model. Particularly, in circumstances where no user-input is received regarding selection and ordering of tasks of a flexible blocks, default rules are used to determine the content of a flexible block and/or its associated constraints, and based upon that determination perform default adaptation operations to generate an instance of the process. For example, one default rule could be to select all tasks (subject to constraints limiting the number of tasks that could be selected) and arrange the selected tasks in parallel (subject to any ordering constraint).

Referring again to FIG. 3, an exemplary embodiment of a handling default rule to examine whether the cardinality constraint associated with the workflow model 200 of FIG. 3 is provided below at Table 2. As explained herein, the cardinality constraint requires that n out of m tasks assigned to the flexible block be selected. The number of tasks that have to be executed may be given during design time.

TABLE 2
Default Adaptation Handling Rule for a Flexible Block
With a Cardinality Constraint

| | |
|---|---|
| r2 | ON FB adapt-complete |
| | IF \|FB\| ≧ 4 |
| | DO execute FB |

As shown at Table 2, upon occurrence of the event adapt-complete, indicating that the flexible block, for example, has been adapted, the condition of whether the adapted flexible block includes at least the number of selected tasks required by the constraint is evaluated. If the condition is satisfied, the flexible block may be executed.

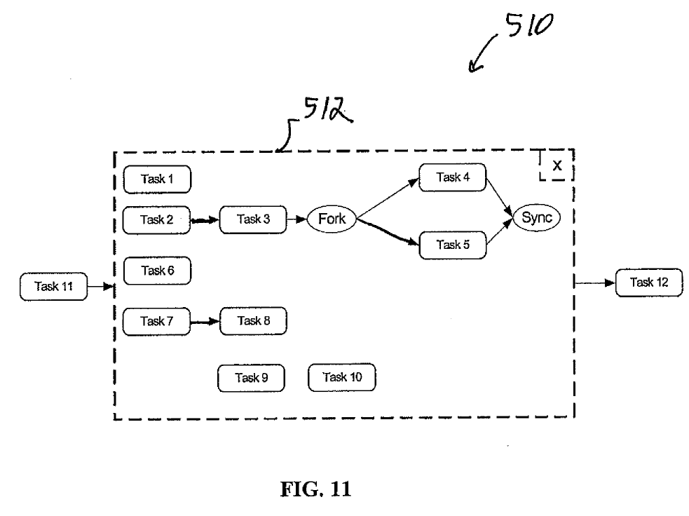

Referring to FIG. 11, an exemplary embodiment of a workflow model 510 with a flexible block 512 associated with a variable cardinality constraint is shown. As previously described, the number of tasks that are to be selected from the tasks assigned to the flexible block 512 is a variable that is assigned a value selected by a user. Variable x can be defined by a user (e.g., domain experts) at pre-deployment (of a process instance) or during runtime. An exemplary embodiment of a handling default rule to examine whether the variable cardinality constraint associated with the workflow model of FIG. 11 is satisfied is provided below at Table 3.

TABLE 3
Default Adaptation Handling Rule for a Flexible Block
With a Variable Cardinality Constraint

| | |
|---|---|
| r3 | ON FB adapt-complete |
| | IF \|FB\| ≧ x |
| | DO execute FB |

Similar to the rule r2, the rule r3 is defined such that upon occurrence of the event adapt-complete, indicating that the flexible block has been adapted, the condition of whether the adapted flexible block includes at least the number of selected tasks required by the variable constraint is evaluated. If the condition is satisfied, the flexible block may be executed.

Referring again to FIG. 5, an exemplary embodiment of a default handling rule associated with the workflow model 220 of FIG. 5 to evaluate a cardinality constraint with mandatory selection of tasks is provided below at Table 4. This type of constraint requires that n out of m tasks assigned to the flexible block be selected, and further requires that certain identified tasks (the tasks identified in the mandatory box 222) be selected. The minimum number of tasks to be executed is generally determined at design time.

TABLE 4
Default Adaptation Handling Rule for a Flexible Block
With a Cardinality Constraint and Mandatory Execution

| | |
|---|---|
| r4 | ON FB adapt-complete |
| | IF \|FB\| ≧ 4 AND |
| | FB contains {T1, T6, T7, T8} |
| | DO execute FB |

The rule r4 is defined such that upon occurrence of the adapt-complete event, indicating that the flexible block has been adapted, the condition of whether the adapted flexible block includes at least the number of selected tasks required by the cardinality constraint is evaluated. Additionally, the condition of whether the tasks identified as mandatory (in this case, Task 1, Task 6, Task 7 and Task 8) have in fact been selected is also evaluated. If the conditions are satisfied, the flexible block may be executed.

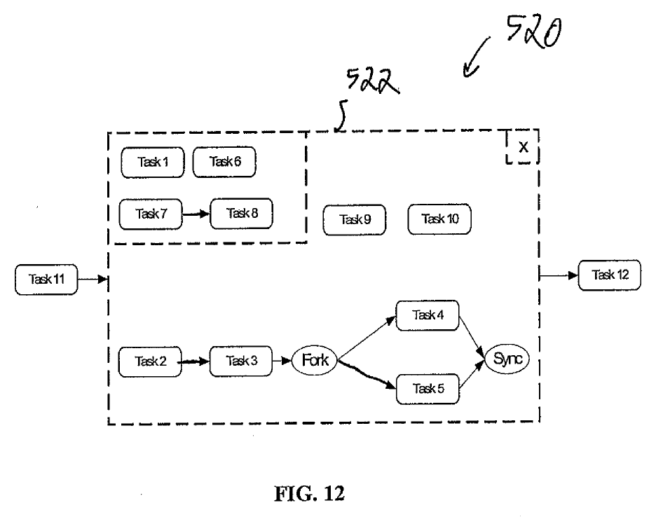

Referring to FIG. 12, an exemplary embodiment of a workflow model 520, corresponding to a particular process, with a flexible block 522 associated with a variable cardinality constraint is shown. As previously described, the number of tasks that are to be selected from the tasks assigned to the flexible block 522 is a variable. Additionally, the constraints associated with the flexible block 522 require that certain tasks be selected. The variable x can be defined by a user (e.g., domain experts) at pre-deployment (of a process instance) or during runtime. An exemplary embodiment of a handling default rule pertaining to the variable cardinality constraint with mandatory task selection is provided below at Table 5.

TABLE 5
Default Adaptation Handling Rule for a Flexible Block With a
Variable Cardinality Constraint and Mandatory Execution

| | |
|---|---|
| r5 | ON FB adapt-complete |
| | IF \|FB\|≧ x AND |
| | FB contains {T1, T6, T7, T8} |
| | DO execute FB |

The rule r5 is defined such that upon occurrence of the adapt-complete event the condition of whether the adapted flexible block includes at least the number of selected tasks set by the user is evaluated. Additionally, the condition of whether the tasks identified as mandatory (in this case, Task 1, Task 6, Task 7 and Task 8) have in fact been selected is also evaluated. If the conditions are satisfied, the flexible block may be executed.

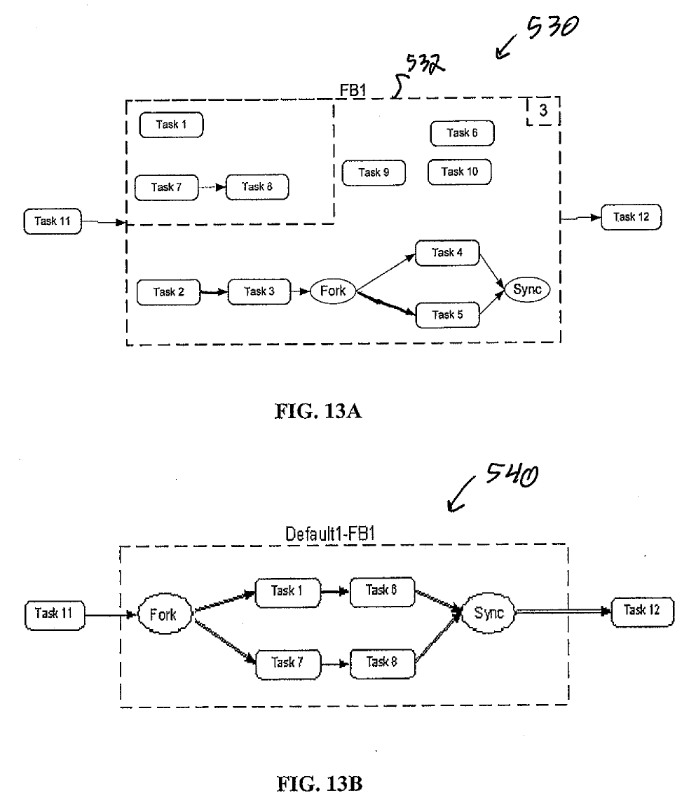

As noted, adaptation handling rules can also be defined for controlling runtime adaptation. To facilitate understanding of the use of default handling rules to control adaptation, reference is made to FIG. 13A showing a workflow model 530 that includes a flexible block 532, and to FIG. 13B showing an instance 540 of the workflow model 530 resulting from, at least in part, application of the default handling rules provided below at Table 6.

TABLE 6
Default Adaptation Handling Rules to Control Adaptation Operations
for a Segment of a Workflow Model With a Flexible Block

| | |
|---|---|
| r6 | ON T11 completes |
| | Do adapt FB1 |
| r7 | ON FB1 no-adapt-response |
| | Do default-adapt FB1 |
| r8 | ON FB1 adapt-complete |
| | IF \|FB1\| ≧ 3 AND |
| | FB1 contains {T1, T7, T8} |
| | Do execute FB1 |
| r9 | ON FB1 completes |
| | Do execute T12 |
| r10 | ON execute FB1 |
| | IF default-adapt |
| | Do execute T1 AND execute T7 |
| r11 | ON T1 completes |
| | IF default-adapt |
| | Do execute T6 |
| r12 | ON T1 completes |
| | IF default-adapt |
| | Do execute T6 |
| r13 | ON T7 completes |
| | IF default-adapt |
| | Do execute T8 |
| r14 | ON T6 completes |
| | IF default-adapt AND T8 completed |
| | Do complete FB1 |
| r15 | ON T8 completes |
| | IF default-adapt AND T6 completed |
| | Do complete FB1 |

Rules r6-r15 are adaptation handling rules for controlling runtime adaptation. It is to be noted that in rule r7, NO-ADAPT-RESPONSE may be an event triggered by an internal timer. The rules r10-r15 are the default behavior rules that control the selection and ordering of the tasks assigned to the flexible block (in the event that no user-input is received in the course of adapting the workflow model). Thus, for example, the rule r10 specifies that upon the occurrence of the execute FB1 event, signalling that the flexible block is to be executed, the condition of DEFAULT ADAPT is evaluated. If it is determined that default adaptation is to be performed (as opposed to, for example, user-controlled adaptation) the action indicated by the rule r10 is to select tasks Task1 and Task 7 and cause them to be performed in parallel. It is to be noted that in this example the adaptation is performed during run-time, but that in other situations a pre-deployment adaptation may be performed so that selection and ordering of the tasks in the flexible block is completed before the tasks are executed.

The rules following the rule r10 control the default-based run-time adaptation and execution of tasks subsequent to the execution of the tasks Task1 and Task 7. Thus, for example, the rule r11 specifies that upon the occurrence of the event corresponding to the completion of the task Task 1, and based on an evaluation that default adaptation is being performed, the action indicated by the rule r11 is to select the task Task 6 to be performed. In other words, through use of the default handling rules, the task Task 6 is adapted to be performed following completion of Task 1. With respect to the rules r14-r15, when both T6 and T8 are completed, the execution of flexible block FB1 is completed (as indicated by the Sync node). In circumstance in which human-controlled adaptation is performed, the rules r10-r15, which are the default handling rules to generate a process instance in the event no user-input is received, are not performed.

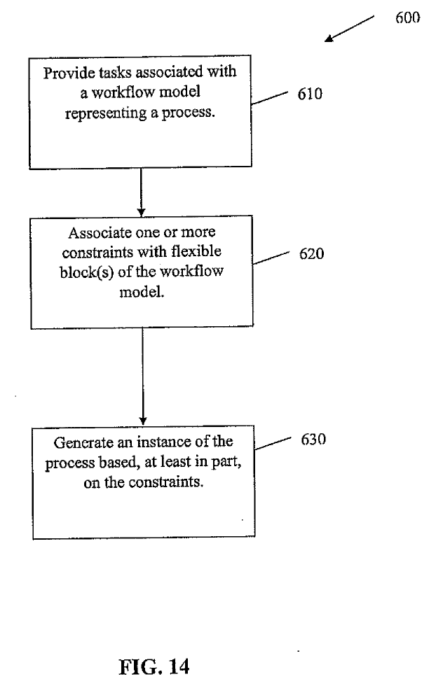

Referring to FIG. 14, a flowchart of an exemplary embodiment of a modeling and adaptation procedure 600 is shown. Initially, tasks associated with a workflow model of a process are provided 610. The tasks provided may have been identified by a user designing a general flexible workflow model. Some of the tasks may be assigned to at least one flexible component, such as the flexible blocks. The general workflow model is design to have enough flexibility so that later modifications, necessitated by changing, and possibly unforeseen circumstances, can be made. Accordingly, one or more of the tasks provided may have an undetermined inter-dependency between that task and the other tasks. “Undetermined inter-dependency” refers to a task's relationship to other tasks (e.g., how the tasks may be linked, in what order are they to be executed, whether that task is to appear in a given generated instance, etc.) is undefined at this point.

As further shown in FIG. 14, one or more constraints are associated 520 with, for example, the flexible block(s) of the process represented by the workflow model. The constraints specify requirements regarding use (e.g., selection and/or ordering) of at least one of the tasks (including tasks whose inter-dependency with other tasks is undetermined). For example, the constraints could specify the number of tasks that need to be selected from a particular flexible block, mandatory tasks to be selected, ordering restrictions, etc. The constraints associated with the process may also be defined by the user who designed the general workflow model.

As further shown in FIG. 14, an instance of the process is generated 630 based, at least in part, on the constraints. The generation of the process instance results in the inter-dependencies of the at least one of the tasks that had undetermined inter-dependencies with other tasks being determined. In addition, upon completion of an adaptation procedure to generate a resultant instance of the process, an evaluation of the generated instance is performed to determine if the generated instance satisfies the requirements specified by the one or more constraints. For example, a determination is made if the number of tasks selected from a flexible block of the process satisfies a constraint pertaining to a minimum number of tasks that had to be selected from that flexible block. In the event that the constraints' requirements are not satisfied, re-iteration of the adaptation procedure may be performed. Although FIG. 14 depicts the generation of an instance of a process based on constraints associated with a flexible block, other items that provide information that contributes to decisions regarding generation of a process instance may be used as well to generate an instance of the process.

As described herein, generating an instance of a process can be accomplished using several adaptation strategies. For example, in some embodiments, generating an instance can be performed using user-controlled adaptation. Under those circumstances, user-input regarding, for example, task selection, task ordering, etc., is received, and the adaptation of the process to generate the process instance is thus based on that received user-input. In some embodiment, generating an instance is performed using default handling rules in which pre-defined rules specify, for example, what tasks to select and/or how to order them. In some embodiments, processes may be adapted by a combination of several adaptation strategies. For example, in a workflow model that has several flexible blocks, some of the blocks may be adapted based on user-input, while other flexible blocks may be adapted using default handling rules.

Referring to FIG. 15 a schematic diagram of an exemplary embodiment of a computing system 700 for modeling workflow processes and performing adaptation procedures thereon is shown. The computing system 700 includes a processor-based device 710 such as a personal computer; a personal digital assistant, a specialized computing device or a reading machine and so forth, that typically includes a central processor unit 712. In addition to the CPU 712, the system includes main memory, cache memory and bus interface circuits (not shown). The processor-based device 710 includes a mass storage element 714, here typically the hard drive associated with personal computer systems. The computing system 700 further includes a keyboard 716, a monitor 720, e.g., a CRT (cathode ray tube) or LCD (liquid crystal display) monitor.

The processor-based device 710 is configured to perform workflow modeling and adaptation procedures, including procedures that provide tasks associated with a process, with one or more of the tasks having undetermined inter-dependencies between the one or more tasks and any of the other tasks, to associate with the process constraints specifying requirements regarding use (e.g., selection) of the tasks and to generate an instance of the process based, at least in part, on the constraints. Generation of the instance is performed through an adaptation procedure, implemented, for example, as a software application executed on the processor-based device 710. The storage device 714 may include a computer program product that when executed on the processor-based device 710 results in the workflow modeling and adaptation techniques described herein.

The processor-based device may further include peripheral devices to enable input/output functionality. Such peripheral devices include, for example, a CD-ROM drive and/or floppy drive, or a network connection, for downloading related content to the connected system. Such peripheral devices may also be used for downloading software containing computer instructions to enable general operation of the respective system/device, and for downloading software implemented programs to perform operations pertaining to the process modeling and adaptation procedures described herein. For example, implemented software modules could include a workflow engine, a rule inference engine, an adaptation engine, etc. Alternatively and/or additionally, in some embodiments, special purpose logic circuitry, e.g., an FPGA (field programmable gate array) or an ASIC (application-specific integrated circuit) may be used in the implementation of the system 700.

Other modules that may be included with the processor-based device 710 are speakers, a sound card, a pointing device, e.g., a mouse or a trackball, by which the user can provide input to the computing system 700. Other kinds of devices can be used to provide for interaction with a user. For example, feedback provided to the user can be any form of sensory feedback, e.g., visual feedback, auditory feedback, or tactile feedback, and input from the user can be received in any form, including acoustic, speech, or tactile input. etc. (none of the additional modules are shown). The processor-based device 710 may include an operating system, e.g., Windows XP® Microsoft Corporation operating system. Alternatively, other operating systems could be used.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Media suitable for embodying computer program instructions and data include all forms of volatile (e.g., random access memory) or non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server arises by virtue of computer programs running on the respective computers and having a client-server relationship to each other.

### APPLICATIONS

Flexible blocks may be used in graph-based process modelling language of commercial Business Process Management Systems (BPMS) or Process Aware Information Systems (PAIS), in support of runtime process adaptation. Examples of applications in which flexible blocks, as described herein, can be used include knowledge intensive workflow application such as patient treatment processes in the healthcare domain and network diagnosis processes in telecommunication domain.

A number of embodiments of the invention have been described. Nevertheless, it will be understood that various modifications may be made without departing from the spirit and scope of the invention. Accordingly, other embodiments are within the scope of the following claims.

What is claimed:

1. A method comprising:
providing tasks associated with a process, one or more of the tasks having a corresponding undetermined inter-dependency between the one or more of the tasks and other of the tasks;
associating with the process one or more constraints specifying requirements regarding use of at least one of the tasks, the one or more constraints having corresponding graphical representations; and
generating an instance of the process based on the one or more constraints to determine the corresponding undetermined inter-dependency between at least one of the one or more of the tasks and the other tasks.

2. The method of claim 1, wherein the associated constraints specifying requirements regarding use of the at least one of the tasks includes associated constraints specifying requirements regarding selecting the at least one of the tasks to be included in the generated instance of the process.

3. The method of claim 1 wherein generating the instance of the process comprises: generating a fully-specified instance.

4. The method of claim 1 further comprising:
receiving a user-input relating to inter-dependencies between the tasks of the process,
wherein generating the instance of the process based on the one or more constraints comprises generating the instance of the process based on the one or more constraints and the received user-input.

5. The method of claim 4 wherein receiving user-input comprises:
receiving user input during at least one of: the generating of the instance of the process and execution of the generated instance of the process.

6. The method of claim 1 wherein generating the instance of the process based on the one or more constraints comprises:
determining whether the generated instance satisfies the requirements specified by the one or more constraints.

7. The method of claim 1 wherein the one or more constraints includes a cardinality constraint specifying a number of tasks that are to be selected from the tasks.

8. The method of claim 7 wherein the cardinality constraint is a variable having an assigned value determined by a user.

9. The method of claim 1 wherein the one or more constraints includes a mandatory execution constraint specifying an identity of one or more tasks from the tasks that have to be performed in the instance of the process.

10. The method of claim 1 wherein generating the instance of the process comprises:
generating the instance of the process based on default rules.

11. The method of claim 10 wherein the default rules include rules that:
specify an event;
cause an evaluation of at least one condition if the event has occurred; and
cause execution of a specified operation based on the evaluation of the at least one condition.

12. The method of claim 11 wherein the event specifies completion of an adaptation of the process and the specified operation causes performance of the process.

13. The method of claim 11 wherein the event specifies that that an adaptation of the process has not been completed and the specified operation causes an adaptation of the process to be performed.

14. The method of claim 11 wherein the specified operation includes selection of one of the tasks.

15. A computer program product residing on a computer readable medium and comprising computer instructions that when executed on a processor-based device cause the processor-based device to:
provide tasks associated with a process, one or more of the tasks having a corresponding undetermined inter-dependency between the one or more of the tasks and other of the tasks;
associate with the process one or more constraints specifying requirements regarding use of at least one of the tasks, the one or more constraints having corresponding graphical representations; and
generate an instance of the process based on the one or more constraints to determine the corresponding undetermined inter-dependency between at least one of the one or more of the tasks and the other tasks.

16. The computer program product of claim 15 wherein the computer instructions further cause the processor-based device to:
receive a user-input relating to inter-dependencies between the tasks of the process,
wherein the computer instructions that cause the processor-based device to generate the instance of the process based on the one or more constraints comprises computer instructions that cause the processor-based device to generate the instance of the process based on the one or more constraints and the received user-input.

17. The computer program product of claim 15 wherein the computer instructions that cause the processor-based device to generate the instance of the process based on the one or more constraints comprise computer instructions that cause the processor-based device to:
determine whether the generated instance satisfies the requirements specified by the one or more constraints.

18. The computer program product of claim 15 wherein the one or more constraints includes a cardinality constraint specifying a number of tasks that are to be selected from the tasks.

19. The computer program product of claim 15 wherein the one or more constraints includes a mandatory execution constraint specifying an identity of one or more tasks from the tasks that have to be performed in the instance of the process.

20. The computer program product of claim 15 wherein the computer instructions that cause the processor-based device to generate the instance of the process comprise computer instructions that cause the processor-based device to:
generate the instance of the process based on default rules.

21. The computer program product of claim 20 wherein the default rules include rules that:
specify an event;
cause the processor-based device to evaluate at least one condition if the event has occurred; and
cause the processor-based device to execute a specified operation based on the evaluation of the at least one condition.

22. A system comprising:
a processor; and
storage device coupled to the processor, the storage device storing computer instructions that when executed on the processor cause the processor to:
provide tasks associated with a process, one or more of the tasks having a corresponding undetermined inter-dependency between the one or more of the tasks and other of the tasks,
associate with the process one or more constraints specifying requirements regarding use of at least one of the tasks, the one or more constraints having corresponding graphical representations; and
generate an instance of the process based on the one or more constraints to determine the corresponding undetermined inter-dependency between at least one of the one or more of the tasks and the other tasks.

23. The system of claim 22 wherein the computer instructions further cause the processor to:
receive a user-input relating to inter-dependencies between the tasks of the process,
wherein the computer instructions that cause the processor to generate the instance of the process based on the one or more constraints comprises computer instructions that cause the processor to generate the instance of the process based on the one or more constraints and the received user-input.

24. The system claim 22 wherein the computer instructions that cause the processor to generate the instance of the process based on the one or more constraints comprise computer instructions that cause the processor to:
determine whether the generated instance satisfies the requirements specified by the one or more constraints.

25. The system of claim 22 wherein the one or more constraints includes one or more of: a cardinality constraint specifying a number of tasks that are to be selected from the tasks and a mandatory execution constraint specifying an identity of one or more tasks from the tasks that have to be performed in the instance of the process.
